(19) United States
(12) Patent Application Publication
(10) Pub. No.: US 2023/0163722 A1
(43) Pub. Date: May 25, 2023

(54) SYSTEM FOR EXTRACTING THERMAL ENERGY

(71) Applicant: Logic IP AG, Zug (CH)

(72) Inventor: Heiko SCHWERTNER, Ebikon (CH)

(21) Appl. No.: 17/908,663

(22) PCT Filed: Mar. 5, 2020
(86) PCT No.: PCT/EP2020/055808

§ 371 Date: Sep. 1, 2022

(51) Int. Cl. H02S 40/44; F24S 10/70; F24S 50/40; F24D 3/00; F24D 19/10; F24D 18/00; H02S 20/23

(52) U.S. Cl. CPC H02S 40/44; F24S 10/70; F24S 50/40; F24D 3/005; F24D 19/1075; F24D 18/00; H02S 20/23; F24D 2101/40

(57) ABSTRACT

The invention relates to a system for extracting thermal energy, a method for operating such a system and a thermal module for such a system. More particularly, the system is for extracting thermal energy from sunlight or other thermic energy sources.

The invention relates to a system for extracting thermal energy, a method for operating such a system and a thermal module for such a system. More particularly, the system is for extracting thermal energy from sunlight or other thermic energy sources.

Solar collectors are used to an ever-increasing extent for the purpose of domestic hot water heating or space heating, which is justified both by increasing environmental awareness and by economic considerations.

Solar thermal systems have at least a solar collector and a water storage tank in which, for example, water to be heated for domestic purposes is stored. The solar collector is connected to a heat exchanger arranged in or on the water storage tank via a heating circuit in which a circulation pump is arranged, which transports the heating medium heated by the solar collector into the heat exchanger of the water storage tank.

Pumps for circulating a heat transfer fluid through solar collectors are part of a so-called solar grid and are usually installed in a building, generally in a boiler room, protected from the weather. The operational reliability of a solar collector depends to a large extent on the integration of the solar collectors into a hot water supply system or heating system.

It is known to control the speed of the circulation pump depending on the heat demand in the water storage tank and the amount of heat provided in the solar collector. The known systems have at least two temperature sensors for this purpose, one in the solar collector and one in the water storage tank. These two temperature sensors must be connected to a control device, which may be integrated into the circulation pump if necessary.

Disadvantages of the installation of such solar grids include the installation effort and space required in addition to the actual collector installation. Also, connections between remote sensors and a central circulation pumps are error prone regarding both mounting and operation.

Improvements for classic solar collector set-ups have been suggested in the past. WO2012/061865, for example, suggests a solar collector characterized in that a pump for circulating a heat transfer fluid through the absorber is arranged on or at least partially inside the collector housing. This solar collector provides no flexibility, though, with regard to how the operation of individual pumps in the collector housings is to be controlled.

EP2806168 relates to a circulation pump unit having an electric drive motor and a control device, wherein at least one internal temperature sensor is arranged in the circulation pump unit, which conveys the temperature of the circulating pump unit medium and outputs a corresponding temperature signal to the control device. The speed control of the control device is, however, only adjustable for the circulation system as a whole or at least for large areas of thermal cells.

It is therefore am objective of the present invention to overcome the disadvantages in the state of the art. It is, in particular, an objective of the present invention to provide a system for extracting thermal energy, preferably from sunlight, which can easily be mounted and efficiently used on various portions of buildings regardless of the geometric orientation, shading situation, north-south exposure of the said portion of the building. The system may flexibly be adapted to changing solar altitudes, seasons and daytimes. It is another objective of the invention to provide a method for operating a system for extracting thermal energy, and a solar thermal module for such a system.

The objective is achieved by a system for extracting thermal energy from sunlight, a method for operating such a system, and a solar thermal module for such a system, having the features of the independent claims.

The invention relates to a system for extracting thermal energy, in particular extracting energy from sunlight, having
a plurality of thermal modules, wherein each module has a housing comprising
a radiation absorber, in particular for the sunlight;
at least one flow channel for a heat extraction medium, wherein the at least one flow channel is arranged adjacent to the radiation absorber;
a flow adjustment actuator, in particular a pump and/or a valve, for transporting and/or controlling the flow of the heat extraction medium through the at least one flow channel; and
a receiver connected to the flow adjustment actuator for receiving an output signal of at least one controller;
at least one controller for controlling the flow control actuators in the plurality of thermal modules (1); and
optionally, at least one sensor for measuring a parameter selected from the group of temperature, pressure, flow rate and light;
   wherein the at least one controller is adapted to individually regulate the flow adjustment actuators of the plurality of modules depending on
data stored in a memory unit (23) connected to the controller; and/or
one or more signal(s) received from the at least one sensor.

The expression “extraction of thermal energy” relates to both heat collection and cooling of excessively heated elements. The object of the extraction of thermal energy can be to collect and utilize heat e.g. for domestic heating purposes. However, the object of the energy extraction can also be to cool certain areas, e.g. portions which tend to overheat such as the surface of solar panels. Ideally, both purposes are achieved at the same time, e.g. in the case of hybrid photovoltaic-thermal systems (PVT-systems).

The thermal module according to the invention has the advantage that each thermal module has its own flow adjustment actuator(s) and its own receiver(s) pertaining to the actuator. Due to these features, each module can individually adjust its conveying capacity, in particular by regulating the pump frequency and/or the valve position. Hence each module can be most efficiently adjusted to the specific needs given by its particular position on the building, such as height, orientation, north-south exposure, and or changing factors, such as solar altitudes, seasons and daytimes.

For this purpose, the at least one controller may control the flow control actuators based on data which has been stored previously in a memory unit by a user or which is automatically added based on astronomic, climatic or meteorological predictions. Alternatively, the at least one controller may control the flow control actuators based on data that is received as a signal from the at least one sensor. A combination of given and measured data is also possible.

The at least one sensor is for measuring a parameter selected from the group of temperature, pressure, flow rate and light. However, there are also multi-sensors which are able to sense different parameters at a time. The use of multi-sensors is part of the scope of the invention.

Possible configurations of the system having at least one sensor include a remote sensor which detects at least one parameter, for example the ambient temperature under the roof of a building. Such a parameter may than be processed by a single controller to give individual instructions, which are to be directed to the receivers of the plurality of modules. Such a system would be a system without feedback loop. Typically, a system could be based on at least one ambient sensor for measuring an external ambient temperature and/or for measuring an external ambient light. In this case, the controller could be adapted to control the flow adjustment actuators depending on the signal received from a few ambient sensors.

However, the skilled person will be well aware, that it is possible and even preferred to have a closed loop system instead or in addition. For example, a sensor for detecting a temperature of a heat extraction medium as it leaves the system of thermal modules according the invention, could provide feedback data to the at least one controller on whether or not pump frequencies should be raised or lowered.

It goes without saying that the controller may be either a central controller configured to send a plurality of individualized output signals to the plurality of receivers connected to the flow adjustment actuators of the system, or that there might be several controllers in use for different clusters of modules (roof tile module cluster, wall tile module cluster, etc.). It might be even preferable, that every thermal module has its own controller.

As is commonly known, in most cases, a central circulation pump will be installed in the building. The central circulation pump may support the work done by the pumps of each module and/or will (co-)determine the flow capacity regulated by the valves. The skilled person will appreciate, that one circuit arrangements as well as multiple circuit arrangements are both encompassed by the scope of the present disclosure. In the case of multiple circuit arrangements, at least two circuits share a common heat exchanger portion. For example, a main circuit actuated by a central circulation pump may share n heat exchanger portions with n individual thermal modules, to accumulate heat.

It is particularly preferred that the thermal module is a flat plate collector. Suitable heat extraction media include water, air, a combination of water and air, nanofluids, thermic fluids, phase change materials (PCM), water enriched with mineral salts or brine.

It is another advantage of the system for extracting thermal energy, that the individual regulation of a flow adjustment actuator per thermal module facilitates cleaning and maintenance of the modules. Modules can be rinsed individually at suitable pressures. Clean modules further support high efficiency of the energy harvesting and extend the service life of the system. For a hybrid photovoltaic-thermal system (PVT-systems), life spam can be extended up to 50%.

It is preferred that the system comprises at least two sensors configured for measuring a parameter selected from the group of temperature, pressure, flow rate and light (intensity and/or wave length); wherein the at least one controller is adapted to periodically receive at least two input signals from the at least two sensors and to individually regulate the flow adjustment actuators of the plurality of modules depending on the at least two signals received from the at least two sensors.

If the system comprises at least two sensors configured for measuring a parameter selected from the group of temperature, pressure, flow rate and light, the flow adjustment actuators of at least two modules, or of at least two clusters of modules can be controlled individually, based on changing parameters. By the term “a cluster of modules” is meant a part of the system comprising a sub-group of modules wherein these modules have in common a similar position on the building. For example, the modules of one cluster may share the same mounting height on the building, the same tilt (saddle roof, flat roof or wall), the same north-south exposure and/or the same location in the shade of a neighboring object. In this context, it is appropriate that the at least two sensors measure parameters of the same type (at least two temperatures, at least to pressures) in order to allow a comparison to be made by the controller(s). It goes without saying, though, that at least two sensors of one kind may be combined with at least two sensors of another kind, e.g. at least two flow rate sensors and at least two temperature sensors may be combined.

It is an advantage of this embodiment of the invention that due to the multiplicity of sensors, the flow adjustment actuators of single thermal modules or of clusters consisting of positionally related thermal modules can be controlled according to their specific needs. This improves the overall efficiency of the system. Overheating of surfaces can be avoided, but also the inefficient circulation of insufficiently heated heat extraction medium can be avoided.

In one embodiment of the system, at least one sensor is comprised in each module and is for measuring a parameter of the heat extraction medium, in particular a temperature, a pressure and/or a flow rate. In an embodiment, a controller is also comprised in each module and is configured for controlling the flow control actuator(s) of the said module.

These embodiments allow the highest extent of individualized operation of the flow adjustment actuators. Also, such a system can be built with highly standardized modules. The system can be particularly easily mounted, and single modules can be replaced in a simple and little error prone fashion.

Another aspect of the invention relates to a system, wherein the at least one controller is adapted to regulate the flow adjustment actuators of the plurality of modules such that a parameter remains within predetermined boundaries.

This system is the system of choice in closed-loop configured systems, when it is desirable to maintain a constant temperature, pressure or flow rate throughout the system or throughout a cluster of modules, measurable at a predefined position within each module. Typical target values include a pressure of no more than 10 bar within the flow channel of a thermal module, or a temperature of no more than 30° C. in proximity of the outlet of the flow channel of a thermal module.

It is preferred that the at least one controller of the system is adapted to regulate the flow adjustment actuators of the plurality of modules such that the pressure of the heat extraction medium in the flow channel remains below 10 bar, preferably between 2-8 bar. This is particularly relevant if the system is a one circuit/larger circuit arrangement. In a one circuit or larger circuit arrangement, i.e. fluidically connecting at least a cluster of individual modules, a central circulation pump will typically move the heat extraction medium from a domestic water processing station to the roof of the building, where it might be temporarily stored and then conveyed further to the plurality of thermal modules.

If the modules run without any pressure control, this typically results in highly varying pressures within different modules. The pressure depends on how many storeys a building has, on where the temporary storage of heat extraction medium is located, on whether or not the building has a flat or a saddle roof, on the position (height) of each thermal module, e.g. on a facade, and on the initial pressure. For example, in a one circuit solution of a two-storey, saddle roof house with a temporary storage of heat extraction medium at the top of the building, the pressure in the flow channel of a thermal module placed vertically on the wall in proximity of the ground can reach 10 bar and more. Such high pressures require special structural measures and materials, which might drive up the prices per module. However, if a flow adjustment actuator is used and controlled based on a measured pressure, the pressure per module can be individually maintained within reasonable boundaries. Standardized modules can be used and wear of parts is reduced. Suitable sensors are commercially available, for example available from IBA-Sensorik GmbH in Mainhausen, DE. They can, for example, be placed within the flow channel downstream of the flow adjustment actuator and provide a feedback signal to the controller in order to allow the speed or position of the flow adjustment actuator to be shut down if the pressure exceeds a preset value.

In another embodiment of the invention, the at least one controller of the system is adapted to regulate the flow adjustment actuators of the plurality of modules such that the temperature of the extraction medium is between 20 and 30° C., preferably between 23 and 27° C. in a proximity of a flow channel outlet. By the term “flow channel outlet” is meant herein either the position where the heat extraction medium leaves the housing or the position where the heat extraction medium enters a heat exchanger portion of the said module. The former applies in the case of one circuit arrangements or larger circuit arrangements which encompass clusters of modules. The latter is relevant for multiple circuit arrangements. Suitable sensors include e.g. NTC Thermistor Sensors with epoxy resin coatings covering a range of −40 to 125° C., e.g. available with Shenzhen RBD Sensor technology.

In an embodiment of the invention, the at least one controller is adapted to regulate the flow adjustment actuators of the plurality of modules depending on the light intensity measured by the at least two sensors. This embodiment is based on the use of ambient sensors. Ambient light sensors can be mounted on an individual module or can be enclosed in an individual module, e.g. underneath the glass cover of a hybrid PVT-module. Alternatively or additionally, ambient light sensors can be placed externally to measure a signal for an entire cluster of positionally related modules. Ambient light sensors are suitable to take into account specific weather conditions but also the shadowing situation affecting the modules, e.g. temporary shielding from sunlight by trees. Suitable sensors include a high precition light sensor photoresistor LS06-B3 (spectral response: 450-1050 nm) by Senba.

It is preferred that the system comprises a plurality of sensors for different parameters. For example, a one circuit arrangement in a building may have individual thermal modules, each having a pressure sensor and a temperature sensor and a controller which periodically receives signals from the said pressure sensor and from the said temperature sensor, hence ensuring, by means of appropriately controlling the pumping rate of a pump, that the pressure of the flow extraction medium in the module never exceeds 8 bar and that the temperature of the heat extraction medium at the outlet always reaches 23-27° C.

It is preferred that the system as described above has solar thermal modules which are hybrid photovoltaic-thermal modules (PVT) and are adapted to generate electric energy. Hybrid photovoltaic-thermal modules are known in the art and are for example described in DE 20 2011 004 424. In such a system, the module additionally comprises at least one photovoltaic cell for generating electric energy. The combination of photovoltaics with solar thermal energy leads to an improvement in efficiency. The heat converted by the solar thermal module can be used directly to heat the building or domestic water. The acquisition costs for photovoltaic systems can be redeemed in a significantly shorter time by using hybrid collectors for lost heat recuperation. Vice versa, in a system as described above, the photovoltaic cell can be electrically connected to the flow control actuator, and optionally to the controller. In this case, the photovoltaic cell supplies the energy-consuming elements of the thermal module with power.

It is preferred that the photovoltaic area is larger than 50% of the absorber are, preferably larger than 80% of the absorber area, more preferably larger than 90% of the absorber area. The photovoltaic cell area and the absorber area overlap at least partially. Ideally, the photovoltaic area is completely undermined by the absorber area.

It is preferred that the system is configured such that the flow adjustment actuator is a pump and the pump is operable in reverse. By means of such a system, the thermal modules can be heated. This is useful, particularly in the cold months of a year. The system for converting solar radiation energy into heat can be used to heat a solar panel.

According to this embodiment of the system, the at least one flow channel of the thermal module is fluidically connected (or shares a heat exchanger portion with a circuit that is fluidically connected) to a heat source. The heat source is operated in such a way that the thermal modules of the system are supplied with thermal energy. This means that the individual module and its surroundings can be heated. The combined heat source can consist of a reversibly operated central circulation pump. The heating of the system by reversing the direction of the heat transport can be particularly useful if the photovoltaic modules are covered with snow and/or ice, which considerably decreases the photovoltaic efficiency. With such a weather-related reduction in the efficiency of the photovoltaic module, it can be advantageous for the building's overall energy balance to invest energy for heating the plurality of modules or a cluster of modules for a short period of time. This allows then to generate photovoltaic electricity again over a longer period of time with the snow- and ice-free modules.

It is preferred, that the flow adjustment actuator is a pump because it allows maximum flexibility of mounting the modules not only on tilted roof areas, but also on horizontal flat roofs or on vertical walls. The pump is particularly useful, if the system is configured to be operable in reverse. In an embodiment, the pump is a piezo pump. A piezo pump is small, economic and long-lived. It goes without saying that small pumps may nevertheless be supported by a powerful central circulation pumps.

For operating the pump in reverse, it is particularly preferable that the presence of snow is detected. In the simplest embodiment, the reverse mode can be enabled manually by a user. Alternatively, the switch from forward to reverse mode, or vice versa, can be triggered automatically through the controller based on the signals received from one or a plurality of sensors. In another embodiment, the reverse mode can be turned on based on information retrieved from a third source, mainly the internet.

Generally, the appropriate controlling of the modes, such as forward and the reverse mode respectively, can be supported by artificial intelligence.

The modules of a system as described above may be connected with neighboring modules in parallel and/or in series. Such connection may be provided by connecting the connecting tube outlet of an upstream module to the connecting tube inlet of a downstream module or the connecting tube inlet of a first module to a connecting tube inlet of a parallel module. More specifically, the housing of the thermal module may comprise a connecting tube inlet and a connecting tube outlet adapted such that the modules can be brought into fluidic communication with each other by connecting the connecting tube inlet or outlet of at first module to a connecting pipe inlet of at least a second module, to form a serial and/or parallel arrangement of modules.

In one aspect, the system as described above has modules, wherein the connecting tube inlet and the connecting tube outlet are fluidically connected with each other via the flow channel of the said module. In this case, the tubes and flow channels form an open circuit for the heat extraction medium. In another aspect, though, the system as described above has modules, wherein the flow channel underneath the radiation absorber forms a closed circuit for the heat extraction medium. In this case, the connecting tube inlet and the connecting tube outlet form part of a second, larger circuit encompassing a plurality of heat removal tubes. The heat is removed in in this second, larger circuit of heat removal fluid. In this case, the module comprises a heat exchanger for exchanging heat between a module's closed circuit of heat extraction and the second circuit of heat removal tubes.

In an embodiment, the system as described has a heat exchanger, such that a portion of the at least one flow channel forms one chamber of the heat exchanger and a portion of the heat removal tube forms an adjacent chamber of the heat exchanger. Preferably, a portion of the heat removal tube of the module may form the outer chamber of a heat exchanger pipe and a portion of the at least one flow channel forms the concentrically arranged, inner chamber of the heat exchanger pipe. In this case, the the heat exchanger pipe has an inlet for a return line of the at least one flow channel and an outlet for a feed line into the module's at least one flow channel.

The invention further relates to a method for operating a system for extracting thermal energy, in particular extracting thermal energy from sunlight, preferably for operating a system according to one of the preceding claims, comprising the steps of:
a. heating a heat extraction medium in a plurality of flow channels disposed within a plurality of thermal modules, wherein the flow channels are arranged adjacent to radiation absorbers of the modules;
b. adjusting the flow of the heat extraction medium in the flow channels of the modules, by means of at least one flow adjustment actuator per module, in particular a pump and/or a valve;
c. measuring a parameter selected from the group of temperature, pressure, flow rate and light, in particular a temperature, a pressure and/or a flow rate of the heat extraction medium;
d. controlling the at least one flow adjustment actuator per module with at least one controller based on the parameter;
e. removing heat by collecting the heat extraction medium, and/or by collecting a heat removal fluid which has been in thermic exchange with the heat extraction medium, from the individual modules.

It is an advantage of this method, that the modules can be adjusted individually depending on their geometric orientation, the (north-south) exposure, their position on the building and/or depending on changing solar altitudes, seasons and daytimes. The over all energy balance of the building can be improved considerably due to such finely adjustable method of operating individual modules or clustered modules of the system. Due to the flow adjustment actuator which is present in the plurality of modules, highly standardized modules can be used. Mounting and replacing becomes easier and more error-resistant.

It is particularly preferred that the parameter is a temperature, a pressure and/or a flow rate of the heat extraction medium and that the controller is controlled such that, e.g. for the individual module, a parameter of the heat extraction medium remains within predetermined boundaries. The use of feedback loops within a thermal module ensures continuous control and of performance and, eventually, optimized energy efficiency.

The method is preferably for operating a system as described earlier and the system may include the listed features. For example, the method may be such that the individual modules are operated in fluidic connection with each other, wherein the modules are connected in parallel and/or in series. The method according to the invention also encompasses a method which comprises an additional step of generating electric energy in photovoltaic cells comprised in the module and, optionally, operating the flow adjustment actuators and/or the controller by electric energy generated in photovoltaic cells comprised in the module.

It is an aspect of the invention that the method comprises the step of reversing the flow direction of the heat extraction medium by reversing the operation mode of the pump, such that the thermal module is heated. In such an embodiment, the flow channels are fluidically connected to a heat source (or are fluidically connected to a heat exchanger portion, which is provided with thermal energy from heat source). As a result of this method, the modules and their immediate surroundings can be heated. Such a configuration is desirable for hybrid PVT modules. As described earlier, this method allows optimized operations in the cold months where the thermal power used for defrosting the thermal panels may be set off by the gain in photovoltaic energy obtained by using the defrosted hybrid photovoltaic-thermal (PVT) modules.

In one aspect of the invention, the method as described above is characterized in that the modules are operated in an open circuit of heat extraction medium. In such a method, the flow adjustment actuators may be valves and the open circuit may be driven or supported by a central circulation pump. In another aspect of the invention the heat extraction medium in a module may be operated by a pump in a closed circuit of heat extraction medium. Preferably, in this case, the heat is transmitted by means of a heat exchanger portion to a heat removal medium contained in a heat removal tube.

In an aspect of the invention, the method comprises the steps of
measuring an external ambient temperature and/or measuring an external ambient light by means of at least two ambient sensors;
controlling the flow adjustment actuators depending on a signal received by the controller from the said at least two ambient sensor.

Such an embodiment is useful if the individual modules or positionally related clusters of modules are to be operated according to specific needs. The at least to sensors in this case provide comparative data for steering the modules of the system or certain clusters of the system, according to the geometric orientation, tilt, north-south exposure of the said portion of the building, as well as changing solar altitudes, seasons and daytimes. For example, by means of a light sensor, coverage of the glass surface of a photovoltaic cell by snow can be detected and a heating mode can be triggered.

The invention further relates to a thermal module, preferably a solar thermal module, for a system as described above. The thermal module comprises:
a. a radiation absorber, in particular for the sunlight;
b. at least one flow channel for a heat extraction medium, wherein the at least one flow channel is arranged adjacent to the radiation absorber;
c. a flow adjustment actuator, in particular a pump and/or a valve, for transporting and/or controlling the flow of the heat extraction medium through the at least one flow channel; and
d. a receiver connected to the flow adjustment actuator for receiving an output signal of a controller.

It is an advantage of such a thermal module, that standardized modules can be used in a versatile manner at any position of a building. They are able to accommodate high pressures of entering heat extraction media, to adjust the flow of the heat extraction medium to meteorological and climatic influences or other factors, and to adopt to radiation conditions on different areas of a building.

It is another advantage of such a thermal module, that the individual regulation of the flow adjustment actuator supports cleaning and maintenance of the module or of the plurality of modules. Modules can be rinsed individually at suitable pressures. Clean modules ensure high efficiency of the energy harvesting and extend the service life of the system. For a hybrid photovoltaic-thermal system (PVT-systems), life spam can thus be extended up to 50%.

In a preferred embodiment, the thermal module additionally comprises at least one of the following elements:
a. a controller for controlling the flow control actuators in the solar thermal module, which controller is adapted to receive (an) input signal(s) from a sensor and to regulate the flow adjustment actuators based thereon; and
b. a sensor for measuring a parameter selected from the group of temperature, pressure, flow rate and light.

The controller serves the purposes of standardization, independence and exchangeability of modules. The sensor allows for adjusting the pump rate/valve position to the specifics of the module's situation. In a preferred embodiment, the detected parameter is a property of the heat extraction medium, in particular a temperature, a pressure and/or a flow rate. Such a parameter can serve as a basis for feedback loops within the module. Due to the use of feedback loops, continuous monitoring and optimization of the operation parameters can be ensured. The controller, in the case of feedback loops, is preferably configured to regulate the flow adjustment actuators of the plurality of modules such that the pressure parameter remains within predetermined boundaries.

The present invention and its advantages will be better understood by referring to the following exemplary description and the drawings which are, however, not meant to limit the scope of the application.

The following figures show:

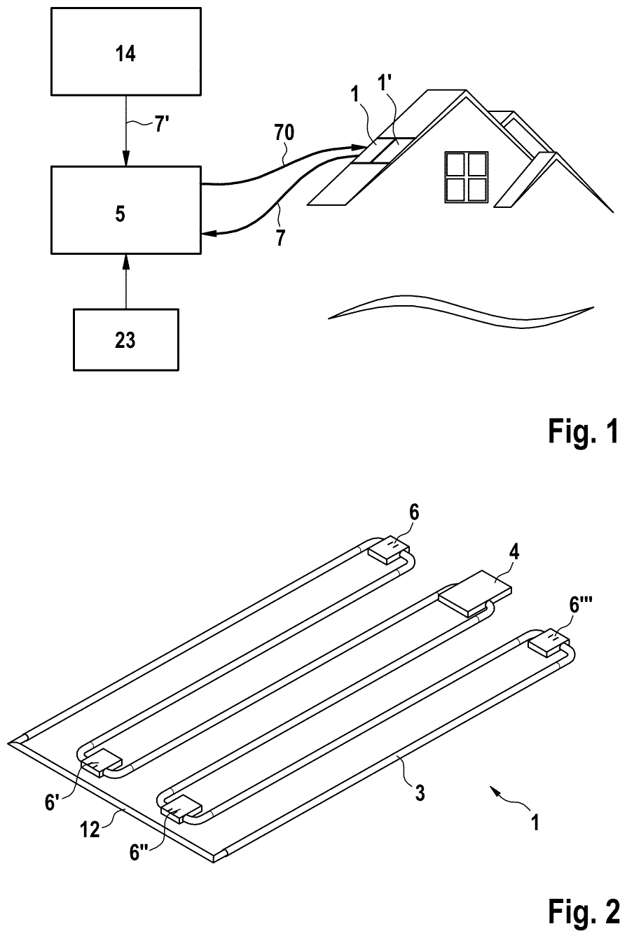

FIG. 1: Schematic view of a system for extracting thermal energy from sunlight;

FIG. 2: Perspective view on selected components of a thermal module;

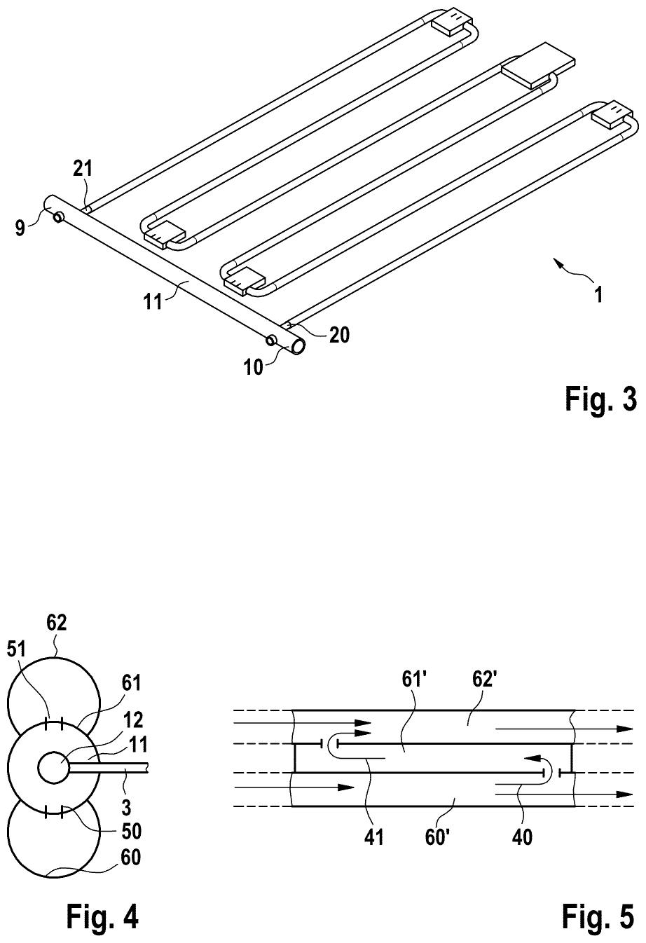

FIG. 3: Perspective view on selected components of thermal module, including a connecting tube;

FIG. 4: Schematic view of a cross section through a heat exchanger tube;

FIG. 5: Schematic view of a longitudinal section through a heat exchanger tube;

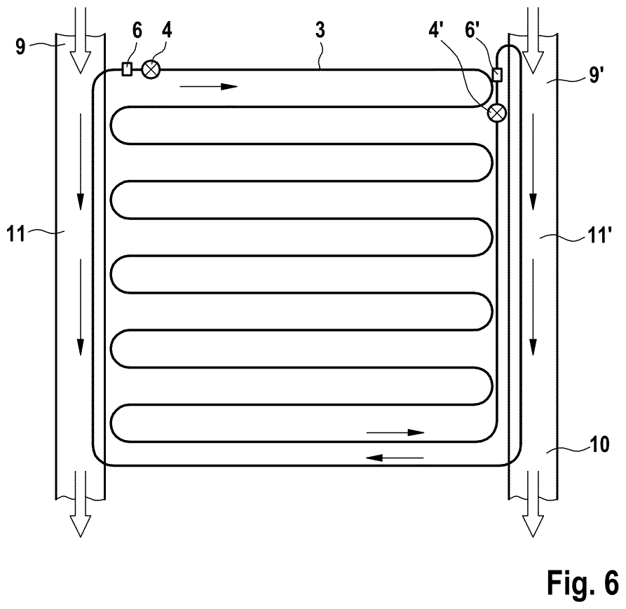

FIG. 6: Schematic representation of a closed-circuit arrangement of a thermal module;

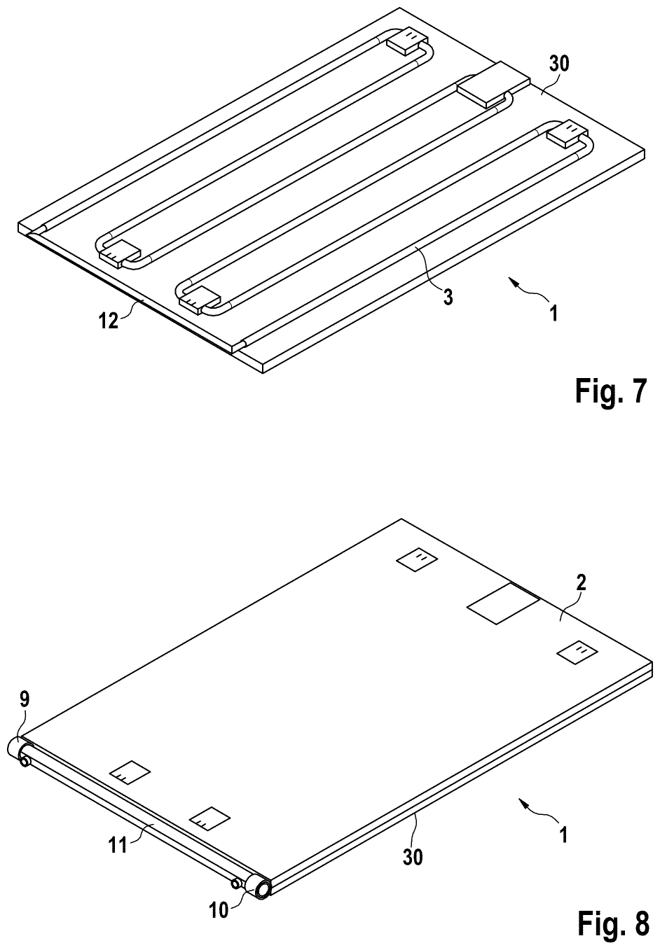

FIG. 7: Perspective view on selected components of a thermal energy module including an insulating layer;

FIG. 8: Perspective view on selected components of thermal energy module including a cover layer;

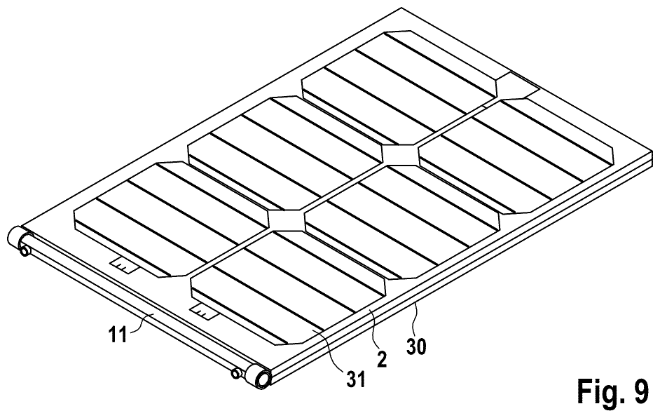

FIG. 9: Perspective view on selected components of thermal energy module including a solar panel of photovoltaic cells;

FIG. 1 shows a schematic view of a system for extracting thermal energy from sunlight. The system has a plurality of thermal modules 1,1′, which are located on top of a saddle roof of a building. Each module 1 has a housing. The components comprised in the housing (radiation absorber, at least one flow channel for a heat ex-traction medium, a flow adjustment actuator, receiver connected to the flow adjustment actuator for receiving an output signal 70 of at least one controller, and optionally: at least one sensor) are not shown in FIG. 1. At least one controller 5 for controlling the flow control actuators in the plurality of solar thermal modules is comprised in the system. The controller 5 receives data, which is stored in a memory unit 23 connected to the controller, and which may consist of, e.g. astronomic, climatic or meteorological data. The controller 5 additionally or alternatively receives one or more signals 7,7′ from at least one sensor. The sensor(s) may be comprised in the housing of a module (6, not shown) or there may be an ambient sensor(s) 14, purposefully placed to detect a parameter which is relevant for an entire region or cluster of the system. The controller 5 is adapted to individually regulate the flow adjustment actuators 4 of the plurality of modules 1 depending on the data received from the memory unit 23, and/or on the signal(s) 7 received from a sensor 6 comprised in the housing of a module, and/or on the signal(s) 7′ received from an ambient sensor 14. In order to regulate the flow adjustment actuators 4 of the plurality of modules 1, the controller 5 sends out an output signal 70 to the receivers of the modules 1,1′.

FIG. 2 shows a perspective view on selected components of a thermal energy module. Shown is a meandering flow channel 3 for a heat extraction medium, which is to be arranged adjacent to the radiation absorber (not shown). In this embodiment, the module is based on a closed circuit set-up with a heat exchanger portion. The straight linear part of the flow channel 3 forms the inner chamber 12 of a heat exchanger pipe. Also shown is a flow adjustment actuator, in particular a pump 4, for transporting the heat extraction medium through the flow channel 3. The flow adjustment actuator is connected to a receiver (not shown) for receiving an output signal 70 of at least one controller 5. The controller may be comprised in the housing of each module or may be located elsewhere for processing the data centrally. The boxes allotted over the length of the meandering flow channel 3 are sensors 6,6′,6″,6′″ for measuring a parameter selected from the group of temperature, pressure, flow rate and light.

FIG. 3 shows a perspective view on selected components of thermal module 1 as depicted in FIG. 2. In addition is shown a heat exchanger tube, including the outer chamber 11. The outer chamber 11 now surrounds the inner chamber 12 over the length of the heat exchanger portion. The outer chamber 11 of the heat exchanger portion at the same time forms the inlet 9 and outlet 10 pieces for connecting neighboring modules 1,1′ in parallel and/or in series. Such connection may be provided by connecting the connecting tube outlet 10 of an upstream module to the connecting tube inlet 9 of a downstream module or the connecting tube inlet 9 of a first module to a connecting tube inlet 9 of a parallel module. The connecting tube inlet 9 and a connecting tube outlet 10 may be adapted such that the modules can be brought into fluidic communication with each other. Furthermore, the outer chamber 11 of the heat exchanger pipe has an inlet opening for a return line 20 of the meandering flow channel 3 and an outlet opening for a feed line 21 into the module's meandering flow channel 3.

FIG. 4 shows a schematic view of a cross section through a heat exchanger tube. FIG. 5 shows a schematic view of a cross section through a heat exchanger tube in a longitudinal direction. The heat exchanger's inner chamber 12 is in fluid communication with the flow channel 3 and is surrounded by the outer chamber 11 of the heat exchanger. In this particular embodiment, the outer chamber of the heat exchanger has three compartments: The cold heat removal medium of a larger circuit flows into the lower compartment 60,60′ of the heat exchanger. Via an opening 50, the cold heat removal medium 40 passes, at least partially, into an intermediate compartment 61,61′ where the main part of the heat exchange occurs. Via another opening 51, the warmed heat removal medium 41 passes into a third, warm compartment 62,62′ in the upper part of the Figures and eventually leaves the module.

FIG. 6 shows a schematic representation of a closed-circuit arrangement of a thermal module. Again, the flow channel 3 is provided as a meandering tube. The heat extraction medium is conveyed by means of two pumps 4,4′. The pump rate of the pump is determined by a controller (not shown) based on the signals received from sensors 6,6′. The shown set-up is particularly suitable for a feedback loop where, for example, the temperature of the heat extraction medium is monitored periodically and the controller is adapted to regulate the pumps 4,4′ such that the temperature of the extraction medium remains between 23 to 27° C. in a proximity of the main tube 11′ of the heat exchanger portion, specifically at the position of the sensor 6′. In this embodiment, the module has two heat exchanger portions. The outer chamber 11 of the cooling portion provides cooling medium 6 at its inlet. The outer chamber 11′ of a heat removal portion removes warm medium 9′ at its outlet 10.

FIG. 7 shows a perspective view on selected components of a thermal energy module. The components are the same as depicted in FIG. 2. However, the flow channel 3, sensors and pump are provided on an insulating layer 30. FIG. 8 shows a perspective view on the components of the thermal module, covered by the radiation absorber 2. The flow channel 3 is placed directly underneath the radiation absorber 2 in order to allow optimized heat transfer. The inlet 9 and outlet 10 of the outer chamber of the heat exchanger portion are further equipped with connecting pieces.

FIG. 9 shows a perspective view on selected components of thermal module including a panel of photovoltaic cells 31. The solar thermal module is a hybrid photovoltaic-thermal (PVT) module and adapted to generate electric energy. In the present case, the solar thermal module is equipped with a 2×3 wafer (6″) and may have a total output of 28 W. Typical dimensions of such photovoltaic surface are 520 mm×360 mm. The current produced by the PV-cells may be used to run the energy-consuming elements of the thermal module. The panel pf PV cells may be provided under a glass plate in an aluminum frame. Each module may contain a junction box with a separating diode and cables (MC4-EU standard). The thermal module is a flat plate collector and its main layers are: the insulating layer 30, the radiation absorber 2 and the panel of photovoltaic cells 31, placed on top of each other.

1.-15. (canceled)

16. A system for extracting thermal energy having a plurality of thermal modules, each module having a housing comprising:
a radiation absorber;
at least one flow channel for a heat extraction medium, wherein the at least one flow channel is arranged adjacent to the radiation absorber;
a flow adjustment actuator for transporting and/or controlling the flow of the heat extraction medium through the at least one flow channel; and
a receiver connected to the flow adjustment actuator for receiving an output signal of at least one controller, the at least one controller for controlling the flow adjustment actuators in the plurality of thermal modules; and
wherein the at least one controller is adapted to individually regulate the flow adjustment actuators of the plurality of modules depending on data stored in a memory unit connected to the controller.

17. The system according to claim 16, wherein the system further comprises at least one sensor for measuring a parameter selected from the group of temperature, pressure, flow rate and light.

18. The system according to claim 17, wherein the at least one controller is adapted to individually regulate the flow adjustment actuators of the plurality of modules depending on one or more signal(s) received from the at least one sensor.

19. The system according to claim 17, wherein the system comprises
at least two sensors configured for measuring a parameter, the at least two sensors selected from the group consisting of temperature, pressure, flow rate and light;
wherein the at least one controller is adapted to periodically receive at least two input signals from the at least two sensors and to individually regulate the flow adjustment actuators of the plurality of modules depending on the at least two signals received from the at least two sensors.

20. The system according to claim 17, wherein the at least one controller is adapted to regulate the flow adjustment actuators of the plurality of modules such that the parameter remains within predetermined boundaries.

21. They system according to claim 16, wherein at least one sensor is comprised in each module and is for measuring a parameter of the heat extraction medium.

22. The system according to claim 20, wherein the at least one controller is adapted to regulate the flow adjustment actuators of the plurality of modules such that the pressure of the heat extraction medium in the flow channel remains below 10 bar.

23. They system according to claim 20, wherein the at least one controller is adapted to regulate the flow adjustment actuators of the plurality of modules such that the temperature of the heat extraction medium is between 20 and 30° C. in a proximity of a flow channel outlet of a module.

24. The system according to claim 17, wherein the at least one controller is adapted to regulate the flow adjustment actuators of the plurality of modules depending on the light intensity measured by the at least one sensor.

25. The system according to claim 16, wherein the thermal module is a hybrid photovoltaic-thermal module and adapted to generate electric energy.

26. The system according to claim 16, wherein the photovoltaic area is larger than 50% of the absorber area.

27. The system according to claim 16, wherein the flow adjustment actuator is selected from the group consisting of a pump and a valve.

28. The system according to claim 16, wherein the flow adjustment actuator is a pump and the pump is operable in reverse such that the thermal module is heated.

29. A method for operating a system for extracting thermal energy comprising the steps of:
a) heating a heat extraction medium in a plurality of flow channels disposed within a plurality of thermal modules, wherein the flow channels are arranged adjacent to radiation absorbers of the modules;
b) adjusting the flow of the heat extraction medium in the flow channels of the modules by means of at least one flow adjustment actuator per module;
c) measuring a parameter selected from the group of temperature, pressure, flow rate and light;
d) controlling the at least one flow adjustment actuator per module with at least one controller based on the parameter; and
e) removing heat by collecting the heat extraction medium, and/or by collecting a heat removal fluid which has been in thermic exchange with the heat extraction medium, from the individual modules.

30. The method according to claim 29, wherein
the parameter is selected from the group consisting of a temperature, a pressure and a flow rate of the heat extraction medium; and
the at least one controller is controlled such that a parameter of the heat extraction medium remains within predetermined boundaries.

31. The method according to claim 29, wherein the flow adjustment actuator is a pump and the method additionally comprises the step of reversing the flow direction of the heat extraction medium by reversing the operation mode of the pump, such that the thermal module is heated.

32. A thermal module for a system according to claim 16 comprising:
a) a radiation absorber;
b) at least one flow channel for a heat extraction medium, wherein the at least one flow channel is arranged adjacent to the radiation absorber;
c) a flow adjustment actuator for transporting and/or controlling the flow of the heat extraction medium through the at least one flow channel; and
d) a receiver connected to the flow adjustment actuator for receiving an output signal of a controller.

33. The thermal module according to claim 32, additionally comprising a controller for controlling the flow adjustment actuators in the solar thermal module, which controller is adapted to receive input signal(s) from a sensor and to regulate the flow adjustment actuators based thereon.

34. The thermal module according to claim 32 further comprising a sensor for measuring a parameter selected from the group of temperature, pressure, flow rate and light.
